(19) United States
(12) Patent Application Publication
(10) Pub. No.: US 2026/0195727 A1
(43) Pub. Date: Jul. 9, 2026

(54) ADMINISTERING EXCLUSIVE MEMBERSHIPS EACH UNIQUELY CORRESPONDING TO A SINGLE NOTABLE FIGURE OR OTHER NON-HUMAN SUBJECT

(71) Applicant: FAN1 LLC, Kirkland, WA (US)

(72) Inventor: Paul Homer, Kirkland, WA (US)

(21) Appl. No.: 19/013,543

(22) Filed: Jan. 8, 2025

(51) Int. Cl. G06Q 20/12; G06Q 30/0601; G06Q 30/08

(52) U.S. Cl. CPC G06Q 20/1235; G06Q 30/0641; G06Q 30/08

(57) ABSTRACT

A facility for managing a set of exclusive memberships each having a single present owner is described. Based on information maintained for the exclusive memberships, the facility generates a display that shows, for each of a subset of them: information identifying a subject of the exclusive membership, and information indicating a value paid by the single present owner of the exclusive membership to become its single present owner. The facility causes the generated display to be presented.

### BACKGROUND

Many people enjoy connecting around subjects to which they're commonly drawn, including the notable figures who interest them. These connections often occur through various mediums, such as face-to-face discussions, online forums, and social media interactions.

### BRIEF DESCRIPTION OF THE DRAWINGS

FIG. 1 is a block diagram showing some of the components typically incorporated in at least some of the computer systems and other devices on which the facility operates.

FIG. 2 is a display diagram showing a sample display presented by the facility in some embodiments to show a membership leaderboard.

FIG. 3 is a display diagram presented by the facility in some embodiments to show details about a membership that is claimed and owned.

FIG. 4 is a display diagram showing a sample display presented by the facility in some embodiments to show information about an unclaimed membership.

FIG. 5 is a display diagram showing a sample display presented by the facility in some embodiments to show details of a user of the facility.

FIG. 6 is a display diagram showing a sample display presented by the facility in some embodiments to show a user details about the memberships the user owns.

FIG. 7 is a display diagram showing a sample display presented by the facility in some embodiments to show details of a particular membership owned by the user.

FIG. 8 is a display diagram showing a sample display presented by the facility in some embodiments to show a newsfeed about memberships that a particular user is following.

FIG. 9 is a display diagram showing a sample display presented by the facility in some embodiments to show a first view of membership exchange activity by a particular user.

FIG. 10 is a display diagram showing a sample display presented by the facility in some embodiments to show a second view of membership exchange activity by a particular user.

FIG. 11 is a display diagram showing a sample display presented by the facility in some embodiments to show a third view of membership exchange activity by a particular user.

FIG. 12 is a display diagram showing a sample display presented by the facility in some embodiments to show a fourth view of membership exchange activity by a particular user.

FIG. 13 is a data structure diagram showing an object architecture used by the facility in some embodiments.

FIG. 14 is a flow diagram showing a process performed by the facility in some embodiments to act on behalf of an administrative user or automated process.

FIG. 15 is a flow diagram showing a process performed by the facility in some embodiments to act on behalf of a beneficiary.

FIG. 16 is a flow diagram showing a process performed by the facility in some embodiments to act on behalf of a fan.

FIG. 17 is a flow diagram showing a process performed by the facility in some embodiments to act on behalf of a membership owner.

### DETAILED DESCRIPTION

The inventors have recognized that people enjoy their interactions about notable figures, and are enthusiastic about new kinds of interaction opportunities.

In response, the inventors have conceived and reduced to practice a software and/or hardware facility for administering exclusive memberships each uniquely corresponding to a single notable figure or other non-human subject (“the facility”). The exclusive memberships (or “memberships”) administered by the facility have a maximum of one owner at a time.

The facility provides a platform that enables people (or “fans”) to bid on or otherwise purchase ownership of a membership. A winning bidder or other purchaser pays a price corresponding their bid to become the membership's owner. In some embodiments, the price of acquiring a membership is imposed periodically, such as every year, quarter, month, week, day, etc. In some embodiments, a user purchases the membership for a specific period of time, such as a year, a quarter, a month, a week, etc.; in some embodiments, the user may have the opportunity to renew their ownership of the membership, and/or the membership may be made available to purchase or bid on by all of the users. In some embodiments, the facility divides the price paid between the subject (“beneficiary”) and an operator of the facility.

In some embodiments, the facility establishes memberships for subjects that may include public figures; people who are less well known; geographical places; organizations; creative works; physical things such as types of trees, car models, foods, consumer products; fictional people such as comic book characters, movie characters, deities; ideas such as love, marxism, hygge; common and slang words, e.g., basketball, y'all, skibidi.

In some embodiments, the facility provides public information about each membership, including identifying information about the subject, price history for the membership including the price most recently paid, present ownership of the membership unless the owner has opted out of being identified, etc. In some embodiments, the facility provides a control that a fan can use to bid on the membership. In some embodiments, the facility presents to fans a ranking of memberships, based on factors such as how high a price was paid for the membership, how recently the membership was purchased, etc.

In some embodiments, the facility provides the owner of a membership with special benefits relative to the subject, such as the exclusive opportunity to communicate with the subject or a representative of the subject, such as by exchanging textual messages. In some embodiments, for a non-human subject such as a museum, the owner can communicate with a due representative of the subject, such as the museum's curator, or post textual messages about the museum on a public forum.

In some embodiments, the facility stores ownership information about each membership in a private database accessible only to the operator of the facility, not a blockchain or other public database. In some embodiments, elements of the stored ownership information are visible publicly.

By operating in some or all of the ways described above, the facility provides to fans a way to interact about and with subjects of special interest to them, and to those subjects a valuable platform and benefits for their participation in it.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc.

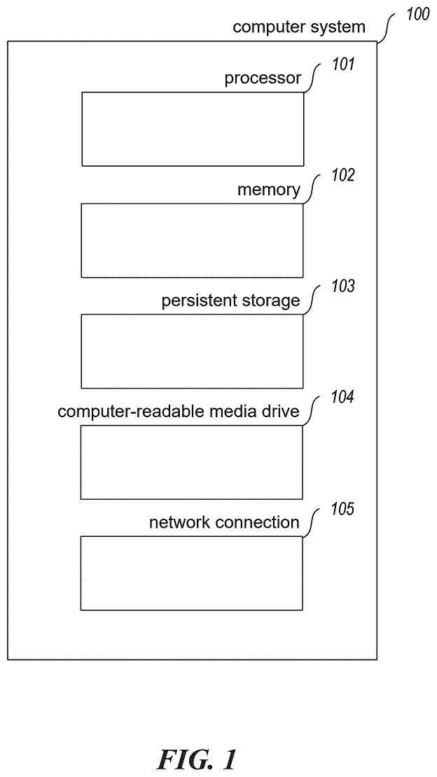

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102—such as RAM, SDRAM, ROM, PROM, etc.—for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components.

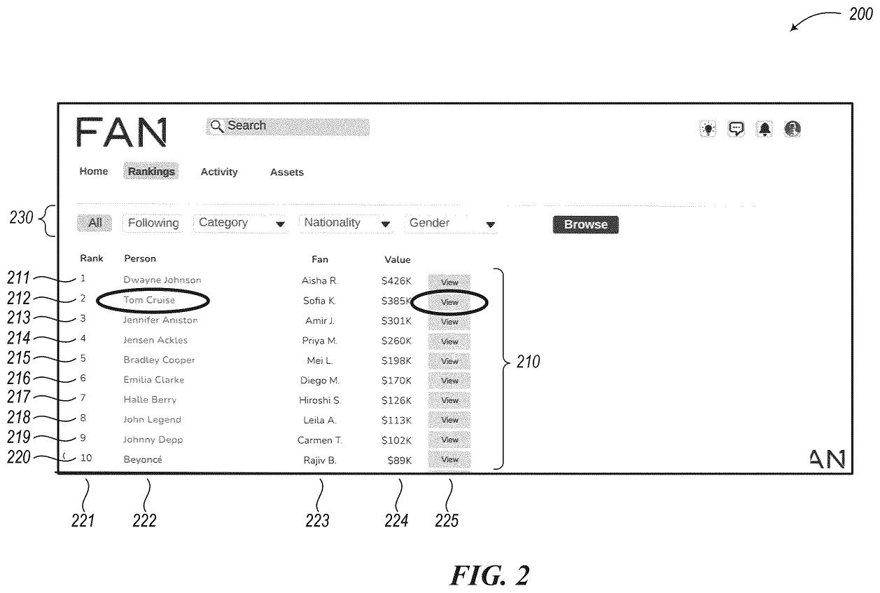

FIGS. 2-12 are display diagrams showing sample displays presented by the facility in some embodiments. In various embodiments, the facility presents such displays using a variety of modalities, including a website accessed by client browsers; a smartphone app; an application installed on a desktop or laptop computer; etc.

FIG. 2 is a display diagram showing a sample display presented by the facility in some embodiments to show a membership leaderboard. The display 200 includes a leaderboard 210 showing the memberships having the highest present values. The leaderboard shows memberships 211-220; for each, it shows a value rank 221, a subject 222, an owner 223, an annualized or otherwise factored price 224 most recently paid for the membership, and a control 225 for displaying additional information about the membership. For example, row 212 that reflects a membership for the subject Tom Cruise has a rank of 2, and is owned by Sofia K., who paid an annualized or otherwise factored $385K for the membership. In some embodiments, the facility supports prices paid in currencies other than a reference currency like U.S. dollars, such as various forms of cryptocurrency, and/or national currencies of other countries; in these cases, in some embodiments, the facility converts the value in the paid currency to a value in the reference currency.

In some embodiments, the facility determines the rank of memberships first by descending value, then by descending length of current owner's membership, then by recency of last purchase, then by alphabetical order of the memberships'names. A user viewing display 200 can activate the control 225 in row 212 to display additional information about this membership.

While FIG. 2 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

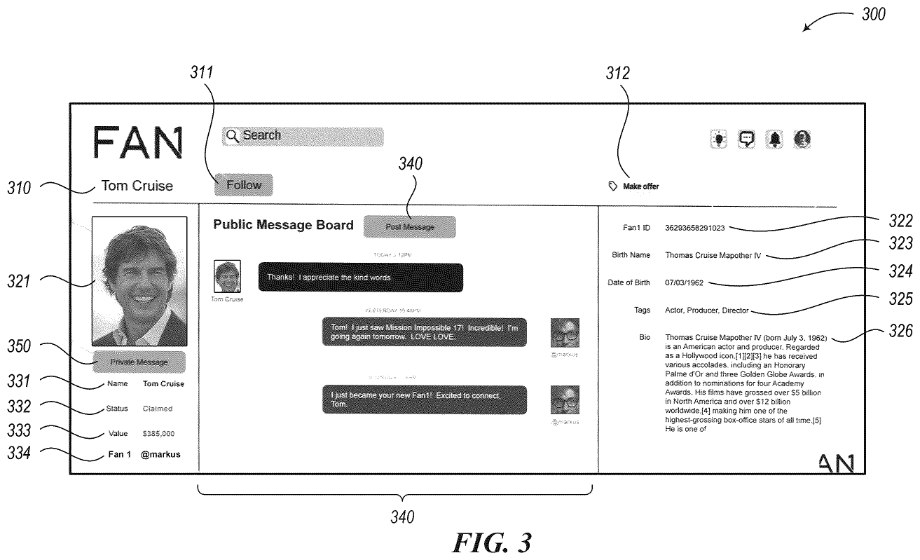

FIG. 3 is a display diagram presented by the facility in some embodiments to show details about a membership that is claimed and owned. The display 300 includes the name 310 of the membership's subject; a follow control 311 that the user can activate in order to follow this subject and receive information in the future about events that relate to the subject, subscription, membership, etc.; and an offer control 312 that the user can use to make a purchase offer for the membership, including specifying a price that the user is willing to pay to purchase the membership. The display may also include a photo 321 or other image of the subject; an identifier 322 for the membership; a birth name 323 for the subject of the membership; a birth date 324 for the subject of the membership; tags 325 for professions or other descriptors of the subject; and a biography 326 or other textual description. The display also includes an indication 331 of the subject's name; 332 of the membership's status; 333 of the membership's value; and 334 of a facility notation. The display further includes a public message board 340 that shows an exchange between different users, and includes a post message control 340 that only the current single membership owner can activate in order to add a message to this exchange. The display also includes a private message control 350 that only the current single membership owner can activate in order to exchange private messages with the subject of the membership.

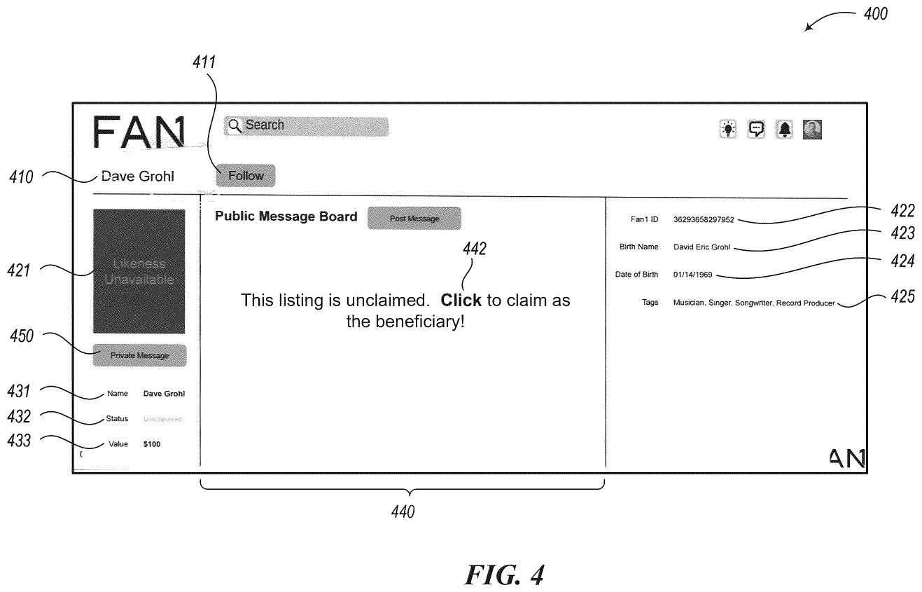

FIG. 4 is a display diagram showing a sample display presented by the facility in some embodiments to show information about an unclaimed membership. The display 400 includes the name 410 of the membership's subject; and a follow control 411 to follow the membership. It further includes a place for an image 421 of the subject; an identifier 422 of the membership; the subject's birth name 423; the subject's date of birth 424; and tags 425 describing the subject. The display further includes the name 431 of the membership's subject, the membership's status 432; and the membership's value 433. The display further includes an indication that the listing is unclaimed by the its subject, and a control 442 that the user can activate to claim the membership as its subject and beneficiary. If the user does this, the facility collects information used to validate a subject's identity; exchange private messages between the subject and whoever is the present owner of the membership; and make payments to the subject arising from purchases of the membership.

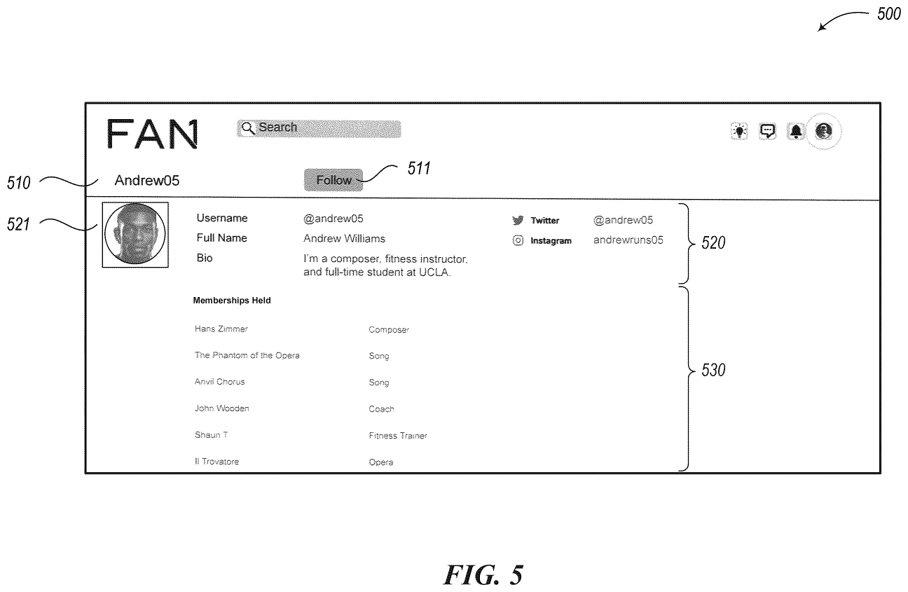

FIG. 5 is a display diagram showing a sample display presented by the facility in some embodiments to show details of a user of the facility. The display 500 includes the user's name 510; and a follow control 511 that the user can activate in order to follow this user. The display also includes identifying information 520 for the user, including an image 521 of the user. The display further includes a list 530 of the memberships (“memberships”) presently owned by the user.

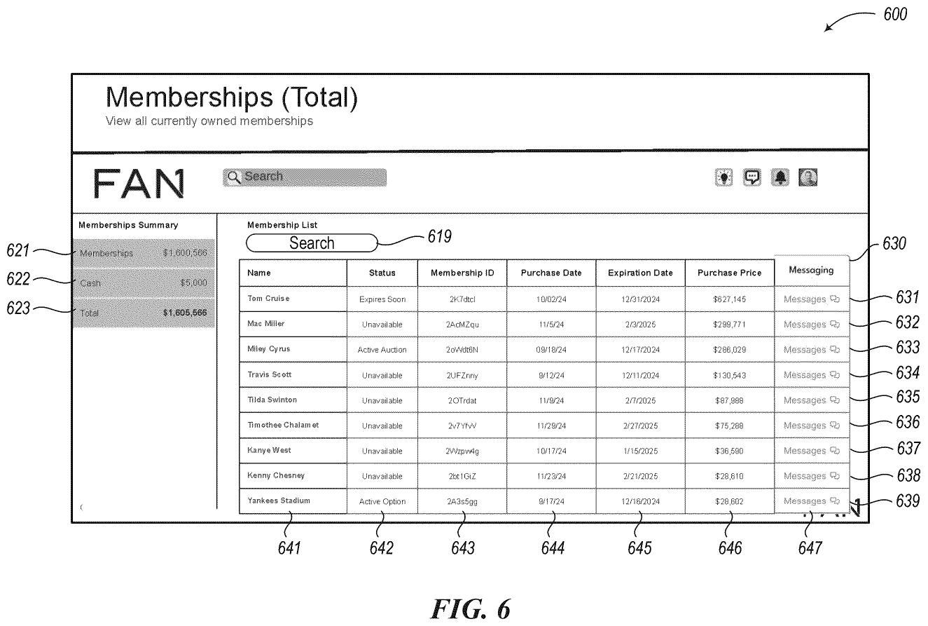

FIG. 6 is a display diagram showing a sample display presented by the facility in some embodiments to show a user details about the memberships the user owns. The display 600 includes a table 630 of the memberships 631-639 owned by this user, as well as a search control 619 that the user can use to search for a particular membership. Each row of the table, corresponding to a different membership owned by this user, is divided into the following columns: a name column 641 showing the name of the membership, such as a name of the subject of the membership; a status column 642 showing the status of the membership and the user's owner of it; a membership id column 643 showing an identifier used by the facility to uniquely identify the membership; a purchase date column 644 indicating the date on which the membership was purchased by the user; an expiration date column 645 including a date on which the user's ownership of the membership may expire; a purchase price column 646 showing a price paid by the user to obtain the membership; and a messaging column 647 containing a messaging control for each membership in order to exchange messages with the subject of the membership, or to post messages to a message board for a membership having a non-human subject. The display 600 further shows the values of the memberships 621 and cash 622 held in the user's account by the facility, as well as a total 623. The display further shows detail 630 about the memberships held by the user, including their total value 621; funds available in the user's account 622; and total account value 623. In some embodiments, the display includes information not shown here, including one or more of: total number of memberships of the memberships held; purchased date of the first membership purchased; total number of bids received for a membership; a last bid that was declined by the user. a history of memberships held by the user, including particular events; controls that the user can activate in order to show a full history of membership transactions; a simple history of membership transactions; a summary of all messages; and a tax statement.

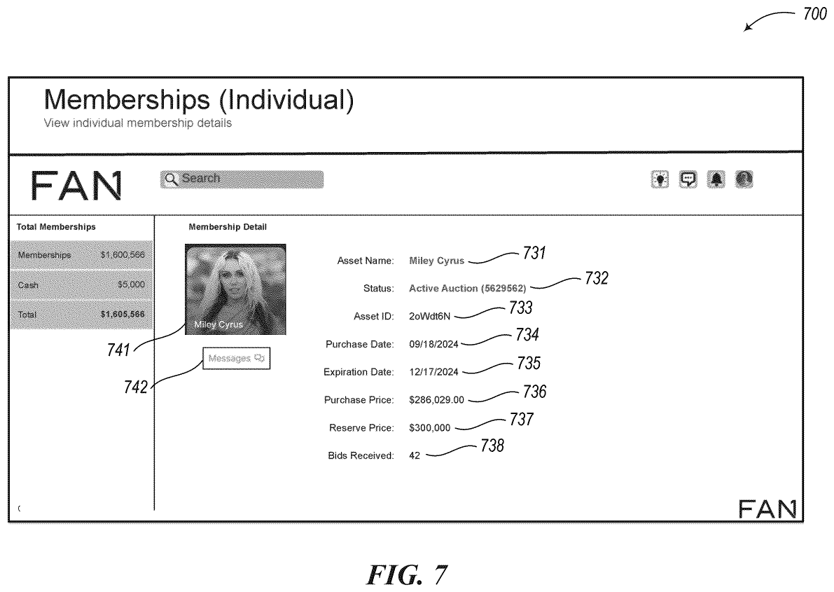

FIG. 7 is a display diagram showing a sample display presented by the facility in some embodiments to show details of a particular membership owned by the user. In some embodiments, the facility presents display 700 in response to the user activating row 633 shown in FIG. 6 for a Miley Cyrus membership. The display includes details about this membership, including its name 731; its status 732; an identifier uniquely identifying it 733; a date 734 on which this user purchased the membership; a date 735 on which the user's ownership of the membership may expire; a price 736 paid by this user for the membership; a reserve price 737 established for the membership; and an indication 738 of the number of bids received in the auction for the membership won by the user. The display also includes an image 741 of the membership's subject, such as a photo, and a control 742 that the user can activate in order to display messages exchanged for the membership, such as with its subject or a representative of its subject. In some embodiments, the display includes information not shown here, including one or more of: a history of this membership, including individual events; a control that the user can activate in order to present a transaction history for this membership; and a control that the user can activate in order to present a summary of messages exchanged about this membership.

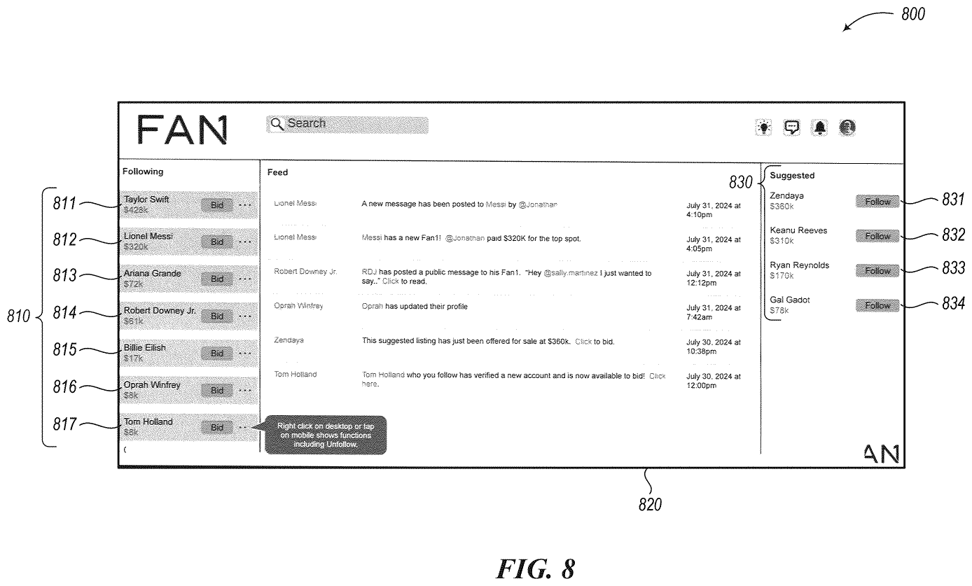

FIG. 8 is a display diagram showing a sample display presented by the facility in some embodiments to show a newsfeed about memberships that a particular user is following. The display 800 includes a list 810 of memberships 811-817 that this user is following; for each of the memberships, its present value is displayed, along with bid control that the user can activate in order to bid on this membership, and an ellipsis control that the user can activate to display additional options with respect to each followed membership, such as unfollowing the membership. The display also includes a feed 820 showing recent activity performed with respect to the followed membership. The display also includes a list 830 of memberships 831-834 that the facility suggests that this user follow based upon the user's other membership follows and related activities. For each of the suggested memberships, the user can activate a follow control in order to add the membership to the memberships followed by the user.

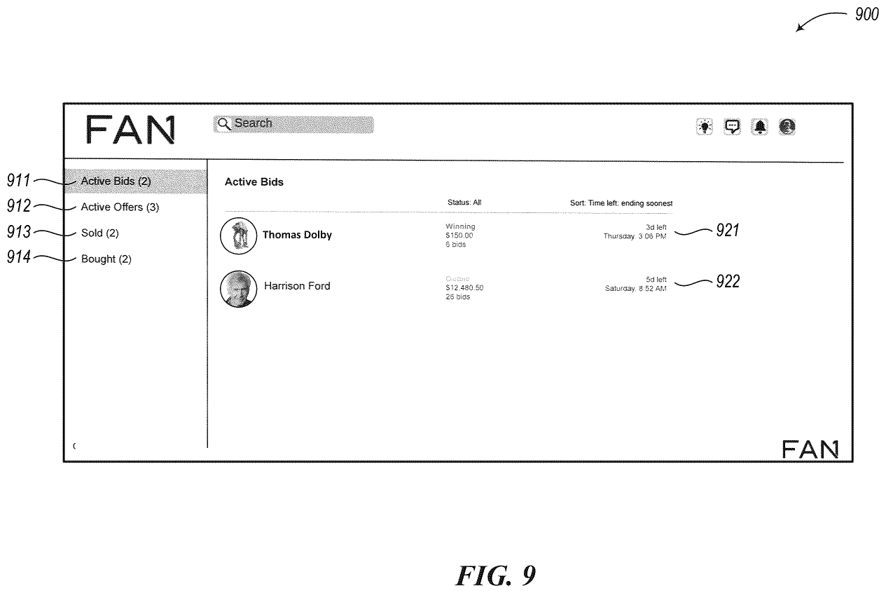

FIG. 9 is a display diagram showing a sample display presented by the facility in some embodiments to show a first view of membership exchange activity by a particular user. The display 900 includes navigation controls 911-914 that the user can activate to view different categories of activity. Here, the user has activated category 911 for active bids-that is, bids that the user has made for memberships that are still outstanding. In this case, two active bids 921 and 922 are shown. For each bid, the facility shows an image, name, status, and amount of time left for others to bid.

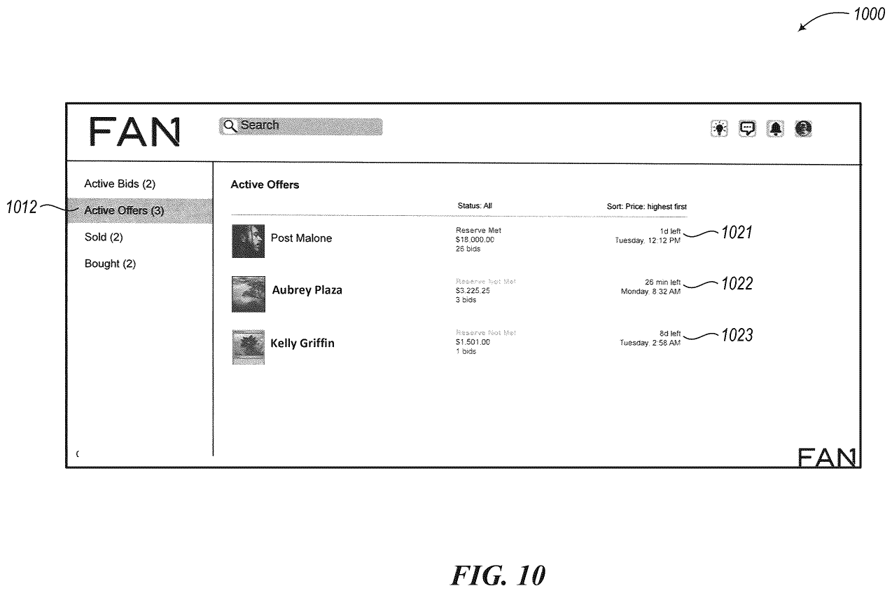

FIG. 10 is a display diagram showing a sample display presented by the facility in some embodiments to show a second view of membership exchange activity by a particular user. In display 1000, the user has activated navigation control 1012 for active offers that the user has received for membership that the user owns. In this case, there are three, offers 1021-1023.

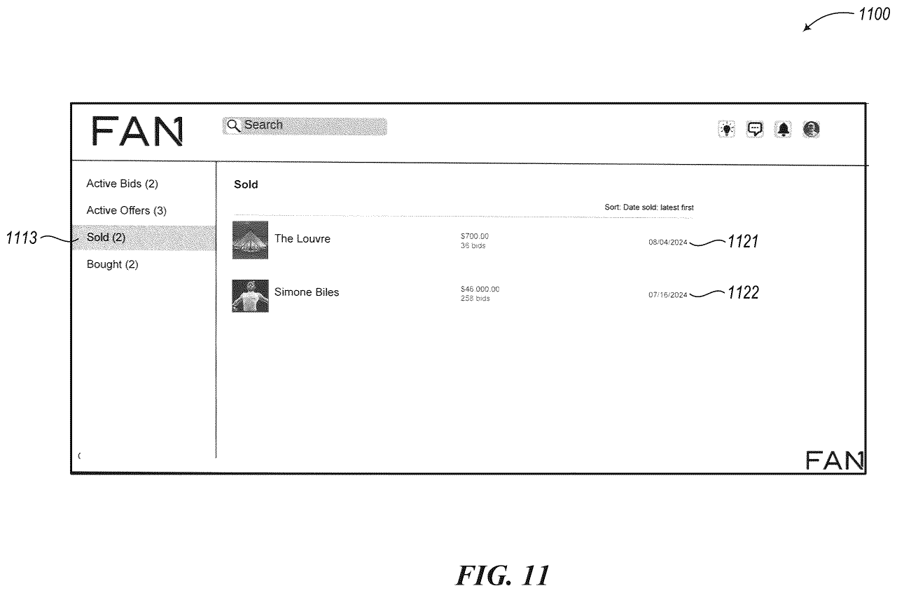

FIG. 11 is a display diagram showing a sample display presented by the facility in some embodiments to show a third view of membership exchange activity by a particular user. In display 1100, the user has activated navigation control 1113 for the sold or expired memberships category. The facility has displayed two former memberships 1121 and 1122 that have expired or been sold to other users.

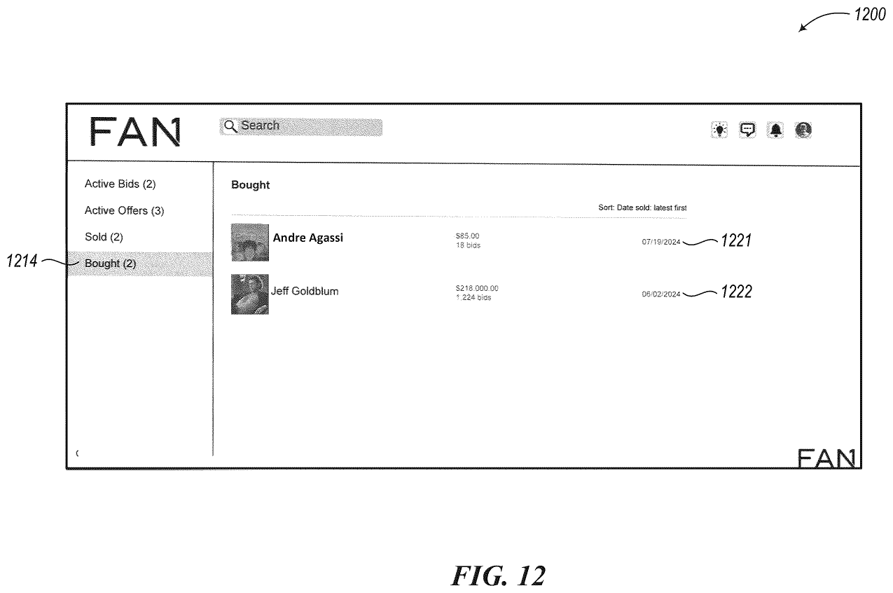

FIG. 12 is a display diagram showing a sample display presented by the facility in some embodiments to show a fourth view of membership exchange activity by a particular user. In display 1200, the user has activated navigation control 1214 to display the category of memberships whose purchase has been completed by the user. Two such memberships, 1221 and 1222 are shown.

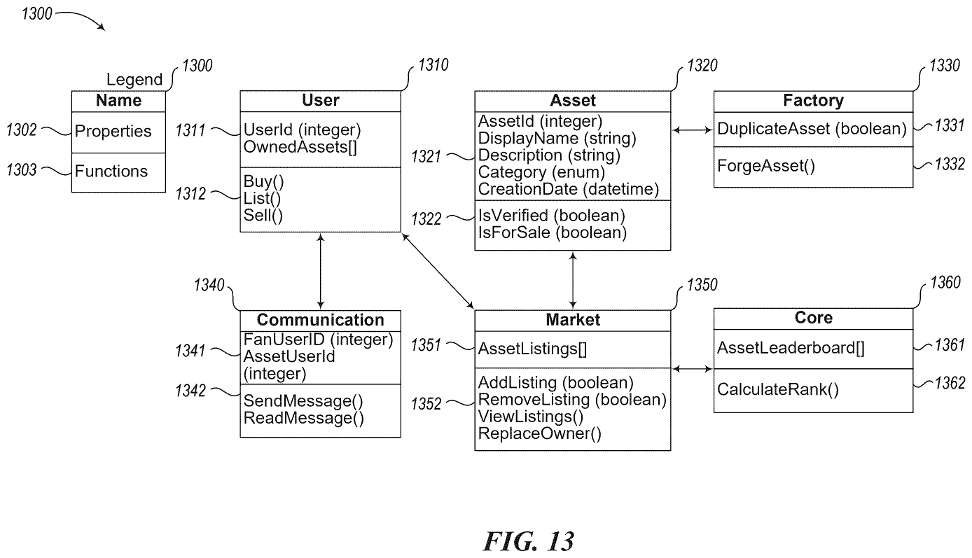

FIG. 13 is a data structure diagram showing an object architecture used by the facility in some embodiments. A legend 1300 shows that each data object type is represented by its name, its data properties 1301, and its functions 1302.

The User data object type 1310 represents all users interacting with the system, including buyers, sellers, and beneficiaries to listed memberships.
Property Examples 1311:
   UserID: Unique identifier.
   OwnedAssets: Array of memberships to which the user is currently the sole owner.
Function Examples 1312:
   Buy: Function of purchasing a membership.
   List: Function of a membership going up for sale to other users.
   Sell: Function of membership transfer to another single user.

The Asset—i.e., membership—data object type 1320 represents the unique memberships to be listed, bought, and sold.
Property Examples 1321:
   AssetId: Unique identifier of each membership.
   DisplayName: Publicly-facing name of the membership.
   Description: Details about the membership.
   Category: Designation of the type of membership.
   CreationDate: When membership created.
Function Examples 1322:
   IsVerified: True or false whether the beneficiary to the membership has been verified by the facility.
   IsForSale: True or false whether the membership is currently for sale.

The Factory data object type 1330 represents the process by which the facility determines that the potential membership is indeed a unique item, and creates the membership.
Property Example 1331:
   Duplicate Asset: True or false whether the membership to be created already exists within the facility. The process to determine duplicate status varies by membership type:
      Human memberships-Names, birth dates, geography, government-issue ID, and/or manual verification used to assess duplicate status
      Non-human memberships-Names, descriptions, geography, ownership, and/or manual verification used to assess duplicate status
Function Example 1332:
   ForgeAsset: Function of creating new memberships within the facility and updating a status to confirm availability either through manual or automated processes once DuplicateAsset status is determined to be false.

The Communication data object type 1340 represents the messaging platform that is only available to beneficiaries of memberships and the sole owner of a membership. Messages can only be sent and received by these two parties and all other messaging is blocked. Users can send and receive multiple messages (one-to-many both ways), though a user must be the owner of a membership at the time in order to send or receive.
Property Examples 1341:
   FanUserId: Unique identifier of the current sole owner of the membership, as they are capable of using the facility communication tools to privately message the beneficiary of the membership or post on the membership's public website page.
   AssetUserId: Unique identifier of the beneficiary to the membership as they can publicly or privately message the current sole owner of the membership.
Function Examples 1342:
   SendMessage: Function of sending messages to another user.
   ReadMessage: Function of displaying messages for reading.

The Market data object type 1350 represents the ecommerce aspect of the service where memberships can be listed for sale and users can purchase or bid on available memberships from the facility or from other users. Each membership could have multiple transactions over time within the marketplace, though each membership will never be listed more than once at any given time ensuring uniqueness and exclusivity. The user has a one-to-many relationship where one user can own via purchase or winning bid many memberships within the marketplace.
Property Example 1351:
   AssetListings: Array of memberships that are currently for sale within the marketplace.
Function Examples 1352:
   AddListing: Function of making a membership available for sale or bid within the marketplace.
   RemoveListing: Function of removing a membership from the marketplace.
   ViewListings: Function of viewing memberships available for sale or bid within the marketplace.
   ReplaceOwner: Function of removing the sole owner of a membership and replacing with the new owner after a sale.

The Core data object type 1360 represents the global ranking system derived from the open marketplace in order to display on the public website. The annualized or otherwise factored last purchase price of each unique membership with a current owner is displayed and values shown in descending order to generate a global popularity/demand scale for memberships by type. Rankings in the core are pulled from current data within the marketplace to confirm ownership, beneficiaries, and prices paid.
Property Example 1361:
   AssetLeaderboard: Table showing global rank, memberships/beneficiaries, the current membership owner, and value, sorted by descending value.
Function Example 1362:
   CalculateRank: Function of calculating each membership's rank amongst all memberships by type, based on annualized or otherwise factored last purchase price and other attributes as necessary for breaking ties (e.g. recency of purchase).

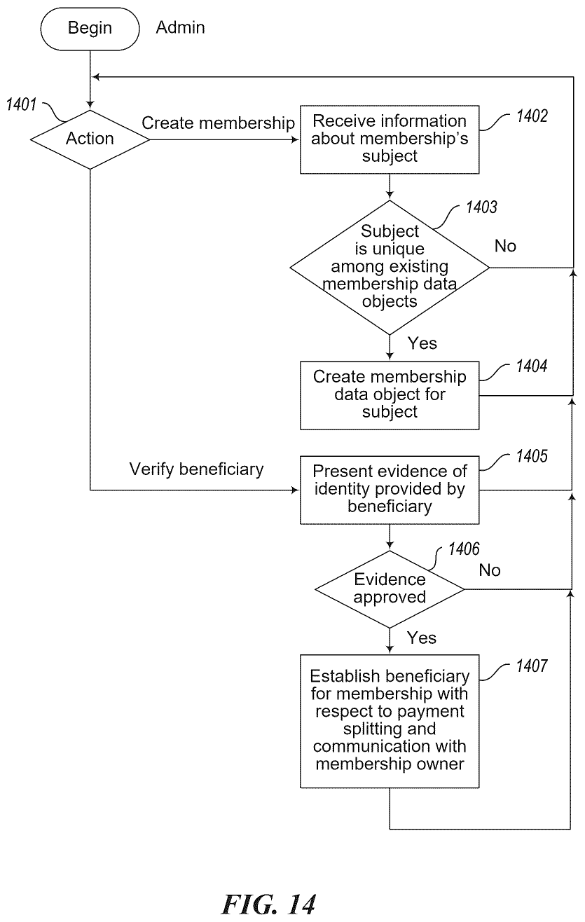

FIGS. 14-17 are flow diagrams showing processes performed by the facility in some embodiments.

FIG. 14 is a flow diagram showing a process performed by the facility in some embodiments to act on behalf of an administrative user or automated process. In act 1401, the facility branches on an action of the administrative user or automated process: if the action is to create a membership, the facility continues in act 1402; if the action is to verify a beneficiary, the facility continues in act 1405. In act 1402, the facility receives information about the subject of the membership, in some cases including the forms of information shown in FIG. 3 and discussed above. In act 1403, if the facility determines that the subject is unique among the existing membership data objects, then the facility continues in act 1404, else the facility continues in act 1401 to process the next action. In act 1404, the facility creates a membership (“asset”) data object for the subject using the information received in act 1402. After act 1404, the facility continues in act 1401 to process the next action.

In act 1405, the facility presents to the administrative user evidence of identity that has been provided by a purported beneficiary of a membership. In act 1406, if the administrative user approves the evidence presented in act 1405, then the facility continues in act 1407, else the facility continues in act 1401 to process the next action. In act 1407, the facility establishes the beneficiary for the associated membership with respect to both receiving the beneficiary's share of payments for the membership, and communicating with the current owner of the membership. After act 1407, the facility continues in act 1401 to process the next action. In some embodiments, certain memberships may have no beneficiary separate from the facility and its operator, such as in the case of some or all memberships having a non-human subject. For these memberships, the facility omits to verify a beneficiary in acts 1405-1407.

Those skilled in the art will appreciate that the acts shown in FIG. 14 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

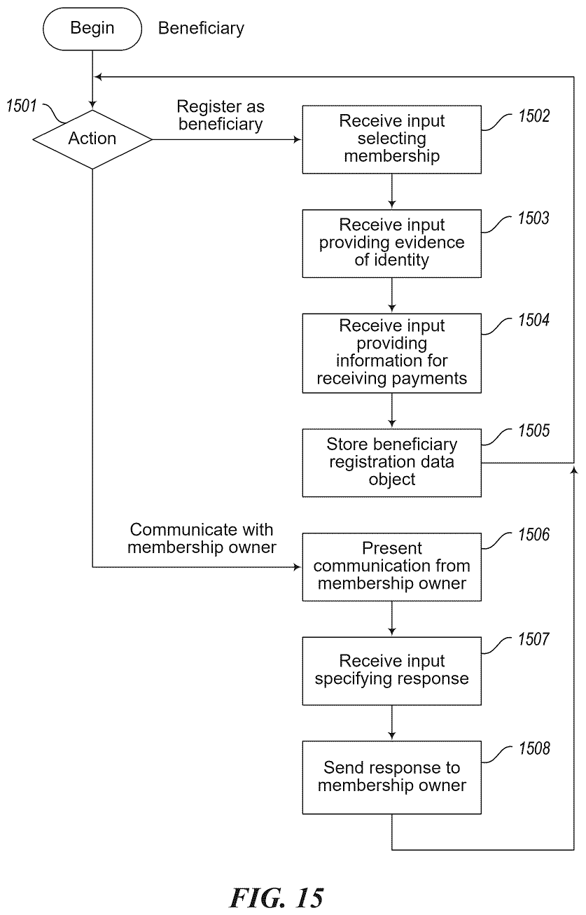

FIG. 15 is a flow diagram showing a process performed by the facility in some embodiments to act on behalf of a beneficiary. In act 1501, the facility branches on an action taken by the beneficiary: if the action is to register as a beneficiary, then the facility continues in act 1502; if the action is to communicate with the owner of the membership for which the beneficiary has been established, then the facility continues in act 1506. In act 1502, the facility receives input selecting a membership for which the beneficiary is seeking to establish themself. In act 1503, the facility receives input providing evidence of the beneficiary's identity, including evidence such as images of physical government identifying documents, electronic signatures or other electronic identification, message from a verified account on a third party platform, photographs of the beneficiary, video segments recorded by the beneficiary, etc. In act 1504, the facility receives input providing information that can be used to make payments to the beneficiary, such as bank account information, a payment app user id, a postal address to which to mail checks, etc. In act 1505, the facility stores a beneficiary registration data object containing the information received from the beneficiary. After act 1505, the facility continues in act 1501 to process the next action. For memberships not having a beneficiary separate from the facility and its operator, in some embodiments the facility omits acts 1502-1505 to register as a beneficiary.

In act 1506, the facility presents communication from the owner of the beneficiary's membership to the beneficiary. In act 1507, the facility receives input specifying a response, such as typed or spoken textual input, an audio recording, a video recording, a hyperlink, etc. In act 1508, the facility sends the response specified by the input received in step 1507 to the membership owner. After act 1508, the facility continues in act 1501 to process the next action.

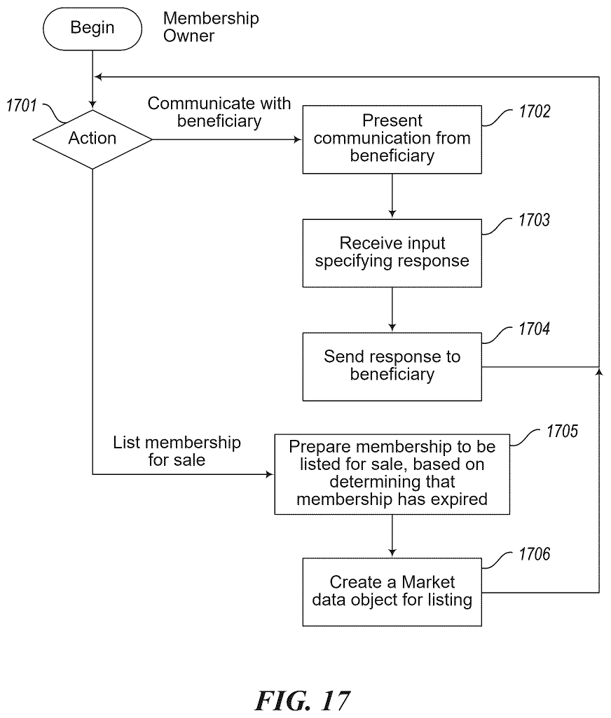

In some embodiments, the communication between a beneficiary or subject of a membership and the membership's owner is such that either participant of this conversation can send a message to the other at any time; with respect to these embodiments, it is not necessary to present a communication from the membership owner in act 1506 before sending a message to the membership owner in act 1508, nor is it necessary to send a response in act 1508 to a received communication presented in act 1506. In these embodiments, the facility is similarly not constrained to the sequence of acts 1702-1704 shown in FIG. 17 discussed below.

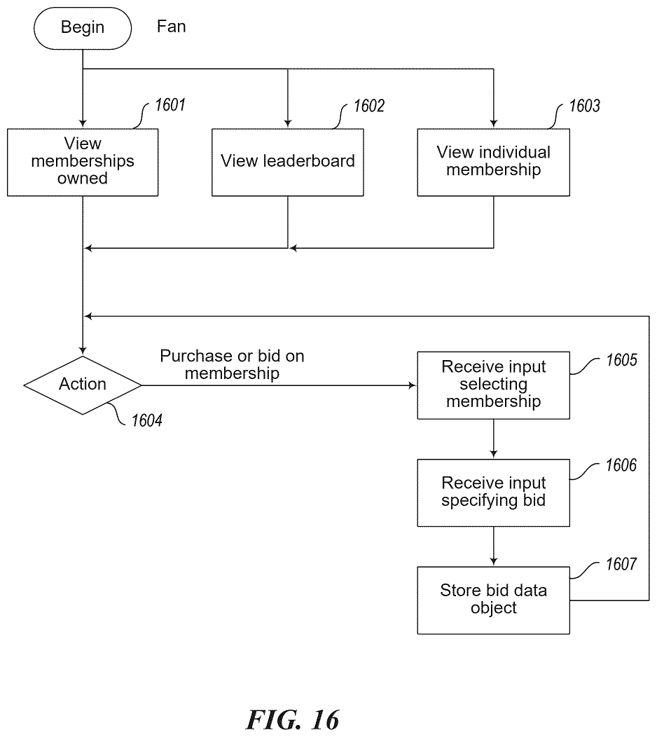

FIG. 16 is a flow diagram showing a process performed by the facility in some embodiments to act on behalf of a fan. In act 1604, the facility branches on an action taken by the fan; where the action is to purchase or bid on a membership not owned by the fan, the facility continues in act 1605. In particular, in act 1604, the user can purchase a membership for which a firm purchase price has been established by the facility, or bid on a membership that is being auctioned by the facility. In act 1605, the facility receives input selecting the membership on which to purchase or bid. In act 1606, the facility receives input specifying an acceptance of the purchase price or the bid amount, and optionally other details such as a maximum authorized bid amount. In act 1607, the facility stores a bid data object on behalf of the fan for the selected membership. After act 1607, the facility continues in act 1604 to process the next action.

In various embodiments, the facility takes various routes to act 1604, including one or more of: in act 1601, displaying to the fan a view of memberships owned by the fan, such as the display shown in FIG. 17 discussed below; in act 1602, presenting to the fan a leaderboard such as the one shown in FIG. 2 and discussed above; in act 1603, presenting details of an individual membership, such as in the display shown in FIG. 7. In various embodiments, the facility reaches act 1603 in various ways, such as in response to the user following a URL or other link, such as a link included in an email or other message, a link included in a third-party website or search result, etc.

FIG. 17 is a flow diagram showing a process performed by the facility in some embodiments to act on behalf of a membership owner. In act 1701, the facility branches on an action of the membership owner: if the action is communicate with the beneficiary, then the facility continues in act 1702; if the action is to list a membership for sale, the facility continues act 1705. In act 1702, the facility presents a communication received from the beneficiary-or subject-of the membership owned by the membership owner. In act 1703, the facility receives input specifying a response, which can be of any of the modes discussed above in connection with act 1507. In act 1704, the facility sends the response specified in act 1703 to the beneficiary. After act 1704, the facility continues in act 1701 to process the next action.

In act 1705, the facility monitors the expiration date of a membership and, based on a set period of time prior to the membership expiration, prepares the membership to be listed for sale. In act 1706, the facility creates a Market data object for the listing. After act 1706, the facility continues in act 1701 to process the next action.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, the method comprising:
causing to be presented to a first user a first display relating to a first exclusive membership is limited to being owned by a single person at a time, comprising:
information identifying a subject of the first exclusive membership,
information identifying the only present owner of the first exclusive membership,
information indicating a price paid by the specified present owner to own the first exclusive membership,
information specifying a minimum price for the first exclusive membership, and
a purchase control;
receiving first input activating the purchase control;
causing to be presented to the first user a second display soliciting a proposed purchase price at least as large as the specified minimum price;
receiving second input specifying the proposed purchase price; and
causing ownership of the first exclusive membership to be transferred to the first user for the proposed purchase price.

2. The method of claim 1, further comprising:
after causing ownership of the first exclusive membership to be transferred, receiving input specifying a private message from the first user to the subject of the first exclusive membership; and
causing the specified private message to be presented to the subject of the first exclusive membership.

3. The method of claim 1, further comprising:
after causing ownership of the first exclusive membership to be transferred, receiving input specifying a public message from the first user; and
causing the public message to be posted on a public page established for the first exclusive membership.

4. The method of claim 1 wherein the subject is a person.

5. The method of claim 1 wherein the subject is a geographical place, an organization, or a creative work.

6. The method of claim 1, further comprising:
receiving bids for the first exclusive membership from one or more additional users, each bid specifying its own proposed purchase price; and
determining that the proposed purchase price specified by the first user is greater than the proposed purchase price specified by the bids from the additional users.

7. The method of claim 1, further comprising:
determining a firm purchase price at which the first exclusive membership can be purchased without competing with other bidders,
wherein the determined firm purchase price is the specified minimum price.

8. The method of claim 1, further comprising
causing to be presented to the first user a third display that shows, for each of a proper subset of a plurality of exclusive memberships that includes the first exclusive membership:
information identifying a subject of the exclusive membership; and
information indicating a price paid by the single present owner of the exclusive membership to become its single present owner; and
while the third display is being presented, receiving third input selecting the first exclusive membership,
wherein the first display is presented in response to receiving the third input.

9. The method of claim 8 wherein the price paid is:
a singular price paid,
a price aggregated from multiple payments occurring over a past period of time,
a price aggregated from a plurality of payments scheduled for a future period of time, or
a price aggregated from one or more payments made during a past period of time and one or more payments and planned for a future period of time.

10. The method of claim 8 wherein the third display shows the exclusive memberships in decreasing order of the indicated price paid for each exclusive membership.

11. The method of claim 8 wherein the generated display shows, for each exclusive membership of the proper subset, the single present owner of the exclusive membership.

12. The method of claim 1, further comprising:
defining an expiration date for ownership by the first user of the first exclusive membership;
upon arrival of the determined expiration date, for a bidding period, soliciting and accepting bids to own the first exclusive membership;
after expiration of the bidding period, identifying a second bidder who made the highest bid on the first exclusive membership; and
causing ownership of the first exclusive membership to be transferred from the first user to the second.

13. The method of claim 12, further comprising:
after expiration of the bidding period and before the identifying, allowing the first user to make a bid higher than the highest bid received during the bidding period, wherein the first user and the second user are the same user.

14-25. (canceled)

26. One or more memories collectively having contents configured to cause a computing system to perform a method, the method comprising:
causing to be presented to a first user a first display relating to a first exclusive membership is limited to being owned by a single person at a time, comprising:
information identifying a subject of the first exclusive membership,
information identifying the only present owner of the first exclusive membership,
information indicating a price paid by the specified present owner to own the first exclusive membership,
information specifying a minimum price for the first exclusive membership, and a purchase control;
receiving first input activating the purchase control;
causing to be presented to the first user a second display soliciting a proposed purchase price at least as large as the specified minimum price;
receiving second input specifying the proposed purchase price; and
causing ownership of the first exclusive membership to be transferred to the first user for the proposed purchase price.

27. The one or more memories of claim 26, the method further comprising:
after causing ownership of the first exclusive membership to be transferred, receiving input specifying a private message from the first user to the subject of the first exclusive membership; and
causing the specified private message to be presented to the subject of the first exclusive membership.

28. The one or more memories of claim 26, the method further comprising:
after causing ownership of the first exclusive membership to be transferred, receiving input specifying a public message from the first user; and
causing the public message to be posted on a public page established for the first exclusive membership.

29. The one or more memories of claim 26 wherein the subject is a person, a geographical place, an organization, or a creative work.

30. The one or more memories of claim 26, the method further comprising:
receiving bids for the first exclusive membership from one or more additional users, each bid specifying its own proposed purchase price; and
determining that the proposed purchase price specified by the first user is greater than the proposed purchase price specified by the bids from the additional users.

31. The one or more memories of claim 26, the method further comprising:
determining a firm purchase price at which the first exclusive membership can be purchased without competing with other bidders,
wherein the determined firm purchase price is the specified minimum price.

32. The one or more memories of claim 26, the method further comprising
causing to be presented to the first user a third display that shows, for each of a proper subset of a plurality of exclusive memberships that includes the first exclusive membership:
information identifying a subject of the exclusive membership; and
information indicating a price paid by the single present owner of the exclusive membership to become its single present owner; and
while the third display is being presented, receiving third input selecting the first exclusive membership,
wherein the first display is presented in response to receiving the third input.

33. The one or more memories of claim 32 wherein the price paid is:
a singular price paid,
a price aggregated from multiple payments occurring over a past period of time,
a price aggregated from a plurality of payments scheduled for a future period of time, or
a price aggregated from one or more payments made during a past period of time and one or more payments and planned for a future period of time.

34. The one or more memories of claim 32 wherein the third display shows the exclusive memberships in decreasing order of the indicated price paid for each exclusive membership.

35. The one or more memories of claim 32 wherein the generated display shows, for each exclusive membership of the proper subset, the single present owner of the exclusive membership.

36. The one or more memories of claim 26, the method further comprising:
defining an expiration date for ownership by the first user of the first exclusive membership;
upon arrival of the determined expiration date, for a bidding period, soliciting and accepting bids to own the first exclusive membership;
after expiration of the bidding period, identifying a second bidder who made the highest bid on the first exclusive membership; and
causing ownership of the first exclusive membership to be transferred from the first user to the second.

37. The one or more memories of claim 36, the method further comprising:
after expiration of the bidding period and before the identifying, allowing the first user to make a bid higher than the highest bid received during the bidding period,
wherein the first user and the second user are the same user.
